(19) United States
(12) Patent Application Publication
(10) Pub. No.: US 2016/0026256 A1
(43) Pub. Date: Jan. 28, 2016

(54) DEVICE FOR ASSISTED MAINTENANCE OF AN AIRCRAFT ENGINE BY RECOGNITION OF A REMOTE MOVEMENT

(71) Applicant: SNECMA, Paris (FR)

(72) Inventors: Charlotte MASSU, Pontault-Combault (FR); Virginie PANNETIER-ROMIEN, Gif Sur Yvette (FR); Eric GARRET, Vert Saint-Denis (FR); Jean-Paul BRUN, Le Chatelet en Brie (FR)

(73) Assignee: SNECMA, Paris (FR)

(21) Appl. No.: 14/804,396

(22) Filed: Jul. 21, 2015

(30) Foreign Application Priority Data
Jul. 24, 2014 (FR) 14 57144

(51) Int. Cl. G06F 3/01; G06F 3/033; G06T 7/20; G06T 7/00; G07C 5/08; B64F 5/00

(52) U.S. Cl. CPC G06F 3/017; G07C 5/0825; B64F 5/0081; G06T 7/20; G06T 7/004; G06F 3/033

(57) ABSTRACT

There is provided a device for assistance with maintenance for an aircraft engine, including computer means; display means; and a human-machine interface. The human-machine interface includes remote movement recognition means to remotely identify a movement or a position of a human operator and to provide corresponding identification data; and a control module, to provide a control command to the computer means in response to the identification data. The computer means are designed to control the display on the display means, of assistance information for maintenance of an aircraft engine, in response to the control command. The computer means are also designed to control holding the content of a display shown on the display means. A method used with such a device is also provided.

### TECHNICAL FIELD

This invention relates to the field of assistance with maintenance of an aircraft, and more particularly maintenance of an aircraft engine. This invention is more particularly applicable to a device providing information to guide an operator in performing a maintenance operation on an aircraft engine.

### STATE OF PRIOR ART

A device is known in prior art for assistance with maintenance of an aircraft engine including a fixed computer station. The station has a processor in which maintenance assistance software is installed and a screen. A technician interacts with the processor through a keyboard and a mouse forming a human-machine interface. Due to the keyboard and the mouse, the technician can send a request to the processor about a maintenance operation on an aircraft. In reply to this request, the processor displays information on the screen to guide the operator in performing said maintenance operation. After reading this information, the human operator may perform this maintenance operation to the best of his ability.

One purpose of this invention is to propose an assistance device for maintenance of an aircraft engine capable of reducing the work time required by the human operator.

### PRESENTATION OF THE INVENTION

This objective is achieved with a maintenance assistance device for an aircraft engine comprising:
computer means;
display means connected to the computer means; and
a human-machine interface for the computer means.

According to the invention, the human-machine interface comprises:
remote movement recognition means designed to identify a movement or a position of a human operator from a distance, and to provide data related to the identified movement or position; and
a control module designed to provide the computer means with a control command in response to reception of data related to the identified movement or position, the computer means being designed to control the display of information for assistance with maintenance of an aircraft engine, on the display means, in response to said control command.

Preferably, the remote movement recognition means comprise a camera to acquire a series of human operator images and means of analysis of images designed to identify a movement or a position of the human operator from said series of images.

According to one advantageous embodiment, the device according to the invention has the following characteristics:
data related to the identified movement or position comprise an identifier of a specific movement or a specific position;
the control module includes a database containing a series of specific movement identifiers and/or specific position identifiers, this database associating a specific control command with each identifier; and
the computer means are designed to control the display of information for assistance with maintenance of an aircraft engine, this display depending on said specific control command provided by the control module.

The device according to the invention may have the following characteristics:
the control module is adapted to move a pointer on a graphic interface displayed by the display means, in response to identification of a movement or a position of the human operator by the remote movement recognition means; and
the computer means are designed to control the display of information for assistance with maintenance of an aircraft engine, this display depending on a control command, called the validation command, provided by the control module, and on the position of said pointer on a specific location of the graphic interface when said validation command is received by the computer means.

The computer means are advantageously designed to control holding, or fixing, the content of a display shown on the display means, in response to the reception of a control command, itself provided by the control module in response to the reception of data related to an identified movement or position.

The computer means may be designed to control stopping said holding the content of a display shown on the display means, in response to reception of a control command, itself provided by the control module in response to reception of data related to an identified movement or position.

Preferably, the device according to the invention has the following characteristics:
the computer means are designed to control the display of maintenance assistance information related to at least one aircraft maintenance operation, each maintenance operation including at least one maintenance step, said information being displayed by the display means; and
the computer means are designed to control a record of the performance of a step in a maintenance operation in response to reception of a control command, itself provided by the control module in response to reception of data related to an identified movement or position.

The invention also relates to a method for assisting the maintenance of an aircraft engine comprising the following steps:
the remote movement recognition means identify a movement or a position of a human operator, and send data related to the identified movement or position;
a control module receives said data related to the identified movement or position, and in response outputs a control command;
the computer means receive said control command, and in response control the display of information for assistance with maintenance of an aircraft engine;
display means connected to the computer means display said information for assistance with maintenance of an aircraft engine.

Preferably, the data related to the identified movement or position comprise an identifier of a specific movement or a specific position, and the method includes the following step:
the control module makes said identifier and a specific control command correspond, to provide the computer means with said specific control command; and
the computer means control the display of information for assistance with maintenance of an aircraft engine, depending on said specific control command.

The method according to the invention advantageously includes the following steps:
displacement of a pointer by remote recognition of a movement of a human operator, to bring this pointer to a specific location on a graphic interface displayed by the display means; and
the computer means control the display of information for assistance with maintenance of an aircraft engine, as a function of a control command called the validation command provided by the control module, and of the position of said pointer on a specific position on the graphic interface when said validation command is received by the computer means.

The method according to the invention advantageously includes a step in which the human operator performs a maintenance operation on an aircraft engine, using maintenance assistance information displayed by the display means in response to an identified movement or a position.

The remote movement recognition means may use the following steps:
acquire a series of images of the human operator;
analyse said series of images to identify a movement or a position of the human operator.

Control over the display of information for assistance with maintenance of an aircraft engine advantageously includes control over holding the content of a display shown on the display means in response to reception of a control command, itself provided by the control module in response to reception of data related to an identified movement or position.

Control over the display of information for assistance with maintenance of an aircraft engine may include ordering stopping of said holding the display content, in response to reception of a control command, itself provided by the control module in response to reception of data related to an identified movement or position.

The method according to the invention preferably includes the following characteristics:
the maintenance assistance information comprises information about at least one maintenance operation, each maintenance operation comprising at least one maintenance step; and
the method includes a step wherein the computer means control a record that a step in a maintenance operation has been performed, in response to reception of a control command, itself provided by the control module in response to reception of data related to an identified movement or position.

### BRIEF DESCRIPTION OF THE DRAWINGS

This invention will be better understood after reading the description of example embodiments given purely for information and that is in no way limitative with reference to the appended drawings in which:

FIG. 1 diagrammatically shows a first embodiment of a device according to the invention;

FIG. 2 diagrammatically shows a second embodiment of a device according to the invention;

FIG. 3 shows a first example of a display showed by the display means of the device according to the invention;

FIG. 4 shows a second example of a display showed by the display means of the device according to the invention;

FIG. 5 diagrammatically shows a first embodiment of a method according to the invention;

FIG. 6 diagrammatically shows a second embodiment of a method according to the invention; and

FIG. 7 shows a human operator using a device according to the invention.

### DETAILED PRESENTATION OF PARTICULAR EMBODIMENTS

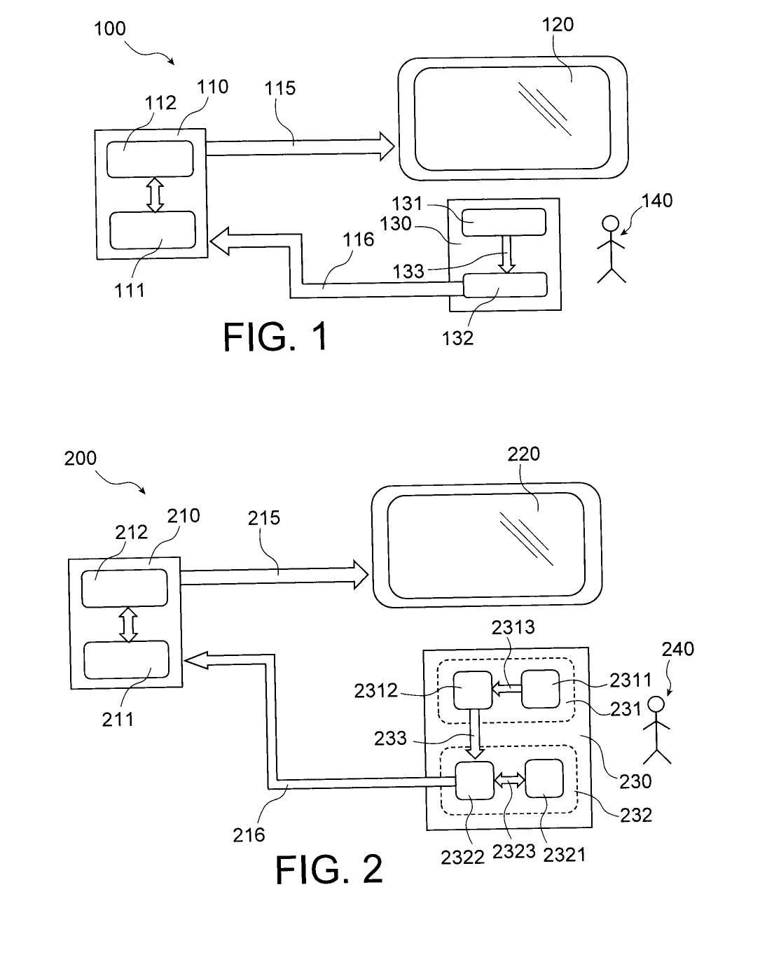

FIG. 1 diagrammatically illustrates a first embodiment of a device 100 according to the invention, for assistance with maintenance of an aircraft engine.

The invention applies to any type of aircraft engine and particular a turbofan that associates a turbojet through which a primary flow circulates and a bladed wheel that drives a secondary concentric flow. The term “propeller” or “turboprop” may be used to denote an aircraft engine according to the invention.

The device 100 comprises computer means 110 providing assistance with maintenance of an aircraft engine. A computer program dedicated to assistance with maintenance of an aircraft engine is advantageously installed on the computer means 110. The computer means 110 consist particularly of a memory 111 and a processor 112. The processor 112 in particular denotes any assembly of electronic components adapted to running instructions and processing data of a computer program. In particular, it may be a microprocessor. The memory 111 denotes an electronic information storage device, for example storing said computer program for assistance with maintenance of an aircraft engine.

The computer means provide aircraft engine maintenance assistance information to a user 140. The maintenance assistance information relates to at least one maintenance operation, each maintenance operation being composed by one or several maintenance steps. Maintenance operations may refer to the replacement or repair of a mechanical part or of an electronic device, in the aircraft engine. Said mechanical part may be a bladed wheel, a compressor, a helix, a turbine, a rotor shaft, a stator shaft, a valve, etc. Said electronic device may be a sensor such as a temperature or pressure sensor, a switch, an electronic control of a valve, etc.

The user 140 is a human operator, particularly a technician specialised in maintenance of aircraft engines.

Maintenance assistance information is sent to the user 140 by display means 120 dedicated to display of aircraft engine maintenance assistance information. The display means 120 are connected to the computer means 110 (arrow 115). The maintenance assistance information encompasses different types of optical data such as diagrams, drawings, animations in two or three dimensions, films, texts or any other type of enriched media.

The display means 120 may in particular display a graphic interface related to the maintenance assistance computer program. This graphic interface includes a presentation of information about various functions provided by said program, in graphic form.

For example, the display means 120 consist of a screen such as a computer screen. The screen 120 in particular denotes any video output peripheral of a computer. For example, it may be a liquid crystal screen. The screen is preferably large, for example with an area of more than 30*30 cm², in order to facilitate remote reading of data displayed on this screen. Remote reading means in particular reading from a distance of more than one meter, for example at least 2.5 m.

The user 140 interacts with the computer means 110 of the device 100 according to the invention through a human-machine interface 130.

Unlike prior art in which the human-machine interface consisted of a keyboard and a mouse, the human-machine interface 130 according to the invention comprises:
means 131 of recognising a movement from a distance; and
a control module 132 for controlling the computer means.

The means 131 remotely identify a movement made by a user 140. Such a movement may for example be a movement of the hands such as wave towards the right, a wave towards the left or a movement from an open palm position to a closed palm position, or a particular movement of the fingers, etc. It may be any movement of part of the user's body, such as a movement of the arm, a movement of the hand, a movement of the fingers, etc. As a variant, the means 131 can identify a position of at least part of the user's body from a distance, for example a position of the arm or the hand or fingers. For example, the means 131 can remotely identify the hand being kept in the fixed position with the palm open for a determined duration, etc. It may be any position of part of the user's body such as the arm, hand, finger kept for a predetermined time lasting of the order of a few seconds. By convention, the term movement recognition means is always used even when these means are adapted to recognise a position. The example of recognition of a movement made by the user only will be described throughout the remainder of this document, for reasons of conciseness.

The means 131 provide the module 132 (see arrow 133) with data related to a movement made by the user 140 and identified by the means 131. These data may include an identifier of a specific movement made by the user, a series of identifiers of elementary movement together forming the movement made by the user, geometric characteristics of successive positions in time, of part of the user's body, etc.

The module 132 receives these data and in response provides the computer means 110 with a control command (see arrow 116). In particular, the module 132 provides the computer means with a control command dealing with execution of a task by the computer means. This task relates to the control of the display of the maintenance assistance information, on the display means 120.

The computer means 110 are designed to control the display of maintenance assistance information on the display means 120 in response to the control command.

The control command may include a command to display maintenance assistance information related to a maintenance operation in particular, a command to scroll the pages of a document displayed by the display means 120, a command to scroll through a menu of a maintenance assistance computer program, etc. The control command depends on the movement identified by the means 131.

Preferably, the control command controls the execution of instructions of the maintenance assistance computer program.

Preferably, the data displayed on the display means, in response, are adapted to remote reading. For example, characters such as letters will have a minimum height of 1 cm on the display means.

According to a first variant of the invention, the computer means 110 control the display of maintenance assistance information as a function of the received control command, and the position of a pointer displayed on the display means at the time at which this control command is received.

Said control command is then a simple validation command associated with a so-called validation movement.

The pointer designates a graphic symbol such as an arrow. It is displayed on the display means and is superposed on a graphic interface like that displayed on the display means. It is more specifically a graphic interface of the maintenance assistance computer program.

The pointer is moved by a pointing device, in this case comprising the remote movement recognition means 131 and the control module 132. The control module 132 is adapted to control displacement of the pointer as a function of a movement made by the user 140 and identified by the remote movement recognition means 131.

The graphic interface has specific locations each associated with a specific display request. These locations may correspond to the position of an icon, a tab in a display window, a row in a graphic interface menu, etc. These different elements may be called “graphic interface pictograms”.

The user 140 must position the pointer at a specific location of the graphic interface associated with a display of specific maintenance assistance information, so that the computer means can display it. When the pointer is located at this specific location, the user then makes a so-called validation movement. The validation movement may for example be the equivalent of a left click on a computer mouse. The validation movement may be a movement such as a first held closed for a few seconds or a hand held with the palm open and immobile for a few seconds, etc. The movement recognition means 131 identify the validation movement and provide the control module with data related to this validation movement. In response to these data, the control module 132 outputs a validation command to the computer means 110. The computer means receive this validation command. When the computer means receive this validation command at the same time as information that the pointer is located at said specific location, they control said display of specific maintenance assistance information. The information according to which the pointer is located at said specific location can be known by the computer means 110, because these same computer means control displacement of said pointer.

According to a second variant, the computer means 110 control the display of maintenance assistance information as a function only of the received control command. The user makes a specific movement directly to make the computer means control the display of specific maintenance assistance information. This specific movement is associated with a specific control command. This specific control command is directly associated with a specific display. When the computer means receive this specific control command, they directly control said display of specific maintenance assistance information.

Thus, in order to obtain a specific display on the display means, a pointer can be placed on a specific location of the graphic interface and validation is made by a validation movement, or more simply a specific movement associated directly with this display can be made. The same display can be obtained by either one or both of the two variants.

In these two variants, data related to the movement identified by the means 131 advantageously comprise an identifier of a specific movement (validation movement or movement directly associated with a specific display) and the control module 132 comprises a database associating an identifier of this specific movement and a specific control command (validation command or control command associated directly with a specific display).

Thus, the user 140 can remotely control the computer means using the device according to the invention. He does not need to manipulate a device like a keyboard, a mouse or a touch screen. The user 140 thus avoids many forward and return movements between the computer means and the aircraft engine on which he is working. This can therefore reduce the total work time for the user 140.

It is also observed that the user 140 can remotely control the computer means without needing to manipulate a device such as a keyboard, a mouse or a touch screen. Thus, he does not need to wash his hands before controlling the computer means. This is an important advantage, particularly when the user 140 is obliged to handle devices covered with engine grease or fuel to perform the current maintenance operation. This also reduces the total work time of the user 140.

Finally, the computer means 110 may be controlled by means of movements such as wide arm movements, by which the user 140 can held a tool in one hand while performing this movement. Thus, there is no need for the user 140 to put down maintenance tools that he is using, to control the computer means. Once again, this can further reduce the total work time of the user 140.

The human-machine interface 130 may include a known device such as a Kinect®, or a Leap Motion® peripheral and an appropriate Application Programming Interface (API). In particular, the programming interface can associate a movement identified by remote movement recognition means of such a known type of device, with control commands according to the invention.

FIG. 2 diagrammatically shows a second embodiment of a device 200 according to the invention. The digital references in FIG. 2 are the same as the digital references in FIG. 1, except that the first digit of each number is replaced by a 2.

FIG. 2 is different from FIG. 1 in that it precisely shows a particular embodiment of the human-machine interface according to the invention.

The human-machine interface 230 comprises remote recognition means 231 and a control module 232.

The remote recognition means 231 include a camera 2311, and image analysis means 2312.

The camera 2311 acquires a series of images of the user 240 in real time, for example in the form of a video file or series of image files. It may be a stereo camera (set of two image sensors).

The camera may acquire images corresponding to infrared wavelengths. For example, it consists of at least one CMOS sensor. As a variant, the camera acquires images corresponding to wavelengths in the visible, and it may consist of a camera forming a computer peripheral called “webcam”.

The remote recognition means 231 may include an infrared projector (not shown) such as a set of light emitting diodes, emitting an infrared signal in a detection space. The camera 2311 then detects infrared radiation reflected by objects located in the detection space, particularly radiation reflected on at least part of the body of the user 240. Such a projector combined with a camera detecting light radiation in the infrared makes it possible to use images of the user 240 regardless of the ambient lighting around the user.

Images acquired by the camera 2311 are transmitted to the image analysis means 2312 (see arrow 2313).

The image analysis means 2312 are designed to identify a movement made by the user 240 starting from the series of images obtained by the camera 2311. Preferably, the image analysis means 2312 realize a three-dimensional reconstruction of the scene observed by the camera. The image analysis means 2312 include computer and software means such as a microprocessor and image processing software. For example, they may be designed to identify one among a series of predetermined movements stored in a memory.

The image analysis means 2312 determine a specific identifier about a specific movement made by the user. To achieve this, they can host a database associating an identifier of a specific movement and a description of this movement. For example, the description of the movement contains geometric data about locations of points in space, a point being associated with a part of the body of the user, such as his a thumb, index finger, etc. The image analysis means 2312 compare the movement made by the user with the specific movements listed in this database, to provide an identifier of the movement made by the user.

The image analysis means 2312 transmit the identifier thus determined to the control module 232 (see arrow 233).

The control module 232 may include a database 2321 containing identifiers like those transmitted by the image analysis means 2312. The database 2321 associates a specific control command with each identifier. Each identifier may for example be a sequence of characters.

A specific control command may include a validation command like that described above, and/or a control command associated with the display of specific maintenance assistance information as defined above.

The database 2321 communicates with calculation means 2322 (see arrow 2323). The calculation means 2322 consist for example of a microprocessor and an adapted software and are adapted, using the database 2321, to select a control command associated with the identifier supplied by the remote recognition means 231.

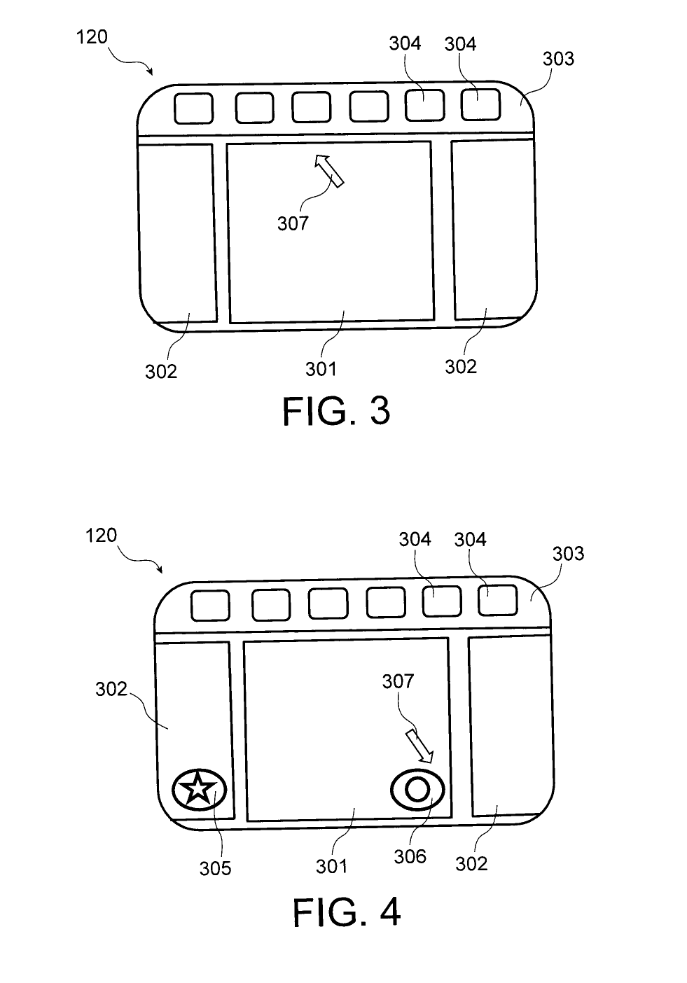

FIG. 3 shows a first example of a display used by the display means 120 of the device according to the invention.

FIG. 3 displays an extract from a document with several pages such as a document in a PDF format. A page of interest 301 is displayed in the centre of the display means 120. The two adjacent pages 302 can be seen on the sides, partially cut off.

FIG. 3 includes a control strip 303 in which there are several icons 304 each associated with the control of the display of specific maintenance assistance information, by the computer means.

Each icon 304 corresponds for example to one of the following functions, each function being related to a specific display:
output,
tutorial,
return,
tree view (so that one document in particular or a particular maintenance operation can be selected to be displayed as a result of successive selections),
manual (to display a user's manual with several pages, the change over to the next page or the previous page being made by moving the hand towards the left or towards the right),
media (to display a series of icons, each associated with a media such as an explanatory video, a 2D or 3D animation, an explanatory diagram, etc. The “media” icon may be combined with a number showing a number of available media and is related to previously selected maintenance operation),
tool (to display a series of icons, each associated with a tool necessary to perform a previously selected maintenance operation. Selection of one among said series of icons displays explanatory data about the corresponding tool),
associated steps (for display of a series of icons each associated with a step in a previously selected maintenance operation. Selection of one among said series of icons displays explanatory data related to the corresponding step. The “associated steps” icon may be combined with a number indicating a number of steps related to the previously selected maintenance operation).

FIG. 3 shows an advantageous function of the device according to the invention. The objective is to be able to temporarily fix the content of a display shown on the display means 120. Thus once this content has been fixed, it remains unchanged regardless of what movements the user is making in front of the remote movement recognition means. The user thus avoids unintentional modification of the display by the display means. Such an unintentional modification may be due to the maintenance gestures to be made.

For example, it may be required to fix a display centred on the page of interest 301.

Therefore the computer means are adapted to control holding the content of a display shown on the display means. Holding the content of the display consists of fixing a display in progress on the display means 120. Preferably, fixing this display will not prevent free displacement of the pointer on a graphic interface displayed by the display means.

If the user wants to hold the display, he moves the pointer 307 to bring it to a specific icon 304 associated with fixing this display. He then makes a validation movement as defined above.

As a variant, a control command may include a so-called blocking command to directly control fixing of a display shown on the display means 120. In this case, the database 2321 is designed to associate this blocking command with a specific so-called blocking movement. The user then simply performs said blocking movement, in front of the remote movement recognition means.

The computer means are also adapted to control stopping fixing the content of a display shown on the display means.

When the user would like to request that the display should be released, all he needs to do is to move the pointer 307 to bring it to a specific icon 304 associated with releasing the display. He then makes a validation movement as described above.

As a variant, a control command may include a command called the release command, to control the release of said fixed display directly. In this case, the database 2321 is designed to associate this release command with a specific movement called the release movement. The user then simply makes said release movement, in front of the remote movement recognition means.

FIG. 4 shows a second example of a display shown by the display means 120 of the device according to the invention.

FIG. 4 is different from FIG. 3 in that an icon related to validation of a step in a maintenance operation is shown on each page 301 and 302.

In FIG. 4, each page applies to a different step in the same maintenance operation.

FIG. 4 shows another advantageous function of the device according to the invention. For the user, the objective is to be able to record information according to which the execution of a step of a maintenance operation is completed. Thus, if the user suspends the maintenance operation and then resumes it later, the maintenance assistance device directly displays data related to the steps following the last step for which the completion was recorded.

Therefore computer means according to the invention are adapted to control recording that a step in a maintenance operation has been done in response to a control command.

When the user would like to request recording an information confirming that a step in a maintenance operation has been completed, all he needs to do is to move the pointer 307 to move it to a specific icon associated with this recording. He then makes a so-called validation movement as defined above.

As a variant, a control command may include a so-called recording command to control such recording directly. In this case, the database 2321 is designed to associate this recording command with a specific so-called record movement. The user then simply makes said record movement in front of the remote movement recognition means.

Registration of information about the performance of a step in a maintenance operation may conduct to a modification of a pictogram on the display of a document related to this step. In FIG. 4, page 302 located at the left of the page of interest corresponds to a step already done by the user and recorded as such. A pictogram 305 on this page specifies the status of the step dealing with this page. The pictogram 305 is said to be a recorded step pictogram. In FIG. 4, the page of interest 301 corresponds to a step that the user is currently performing. A pictogram 306 on this page specifies the status of the step dealing with this page. The pictogram 306 is said to be the pictogram of the current step.

The pictogram 306 may correspond to the icon associated with said recording.

Similarly, the computer means according to the invention may be designed to control continuous scrolling of a document content displayed on the display means such as a film or an animation in two or three dimensions, in response to a control command according to the invention.

This control may be associated with a specific control command called a playback command.

As a variant, when the user would like to watch such a document, he moves the pointer 307 to bring it to a specific icon associated with such a playback. He then performs a so-called validation movement as defined above.

A specific icon associated with such a playback may be associated with a single media.

For example, the user moves a pointer onto a “media” icon as defined above, and then controls selection of this icon by a validation movement. In response, the display means display icons each associated with one among a set of available media. They may only display icons associated each with one among the set of media related to a previously selected maintenance operation.

The user then moves a pointer onto an icon for a particular medium, and then controls selection of this icon by a validation movement. In response, the display means display the content of this media, for example by opening a specific pop-in window.

We will now more specifically describe a method according to the invention. Such a method is advantageously used in a device according to the invention for assistance with maintenance of an aircraft engine. Elements of the method already described in the framework of the description related to the device will not be repeated. In particular, elements belonging to the device according to the invention and implementing at least one step of the method according to the invention will not be described again.

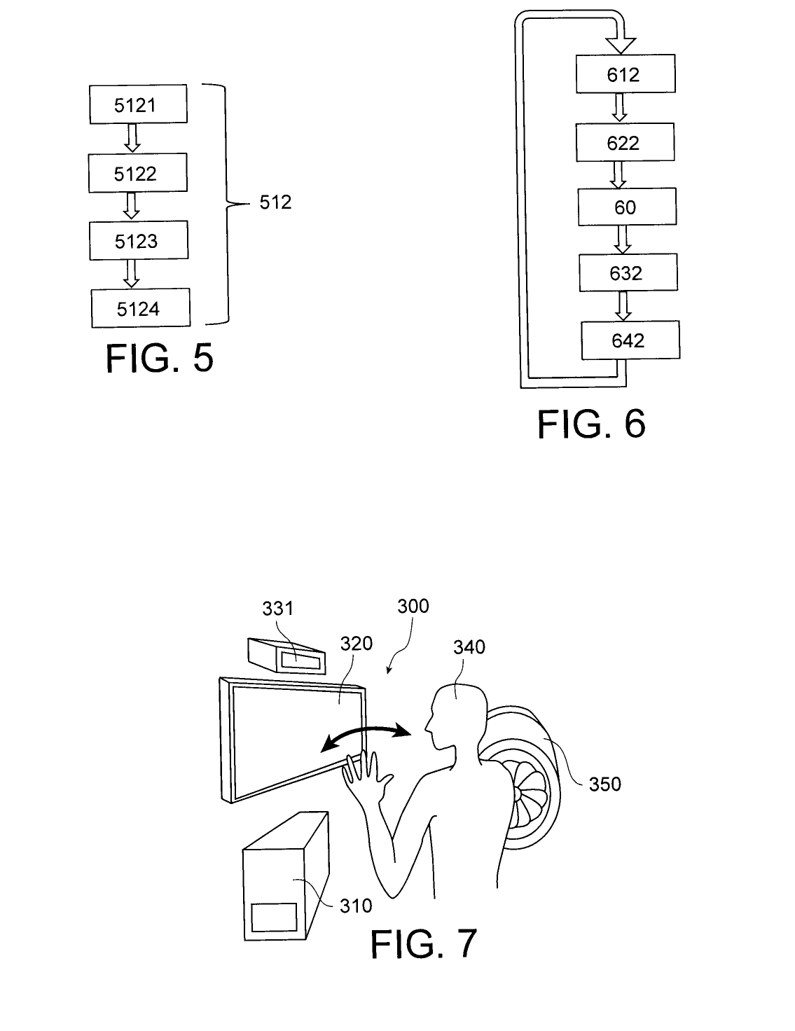

FIG. 5 diagrammatically shows a first embodiment of a method according to the invention used in a device like that described with reference to FIG. 1 or FIG. 2.

A user is within a detection field of remote movement recognition means, for example the field of vision of a camera of these means, or the scanning field of an infrared projector used for recognition of a remote movement. This detection field is usually located facing the display means.

The method according to the invention comprises the following steps:
the remote recognition means identify a movement made by the user (step 5121). They supply data related to the movement made, for example an identifier of this movement. This movement may form one movement among a series of predetermined movements;
the control module receives these data and in response outputs a control command (step 5122);
the computer means receive this control command (step 5123). In response to this control command, the computer means control display of maintenance assistance information by the display means. This control advantageously leads to execution of said control command by the computer means, and particularly execution of instructions in the computer program for assistance with maintenance of an aircraft engine as described with reference to FIG. 1.
display of said aircraft engine maintenance assistance information by the display means (step 5124).

In summary, the invention may consist of browsing through the different menus of a computer program for assistance with maintenance of aircraft engines, through a remote recognition of a movement made by a user.

The method according to the invention may include an initial step in which an infrared projector forming part of the remote movement recognition means scans the user's body. This initial scanning step records data related to the user in order to subsequently facilitate recognition of his movements.

Display of maintenance assistance information may include a display of a computer program menu like that defined with reference to FIG. 1, display of one page related to one step in a maintenance operation, display of the content of a medium such as a video or 3D animation, etc.

Step 5121 may include in particular an acquisition step of a series of user images, followed by a step in which said series of images is analysed in order to deduce data related to the movement made by the user.

Steps 5121, 5122, 5123 and 5124 together form a single step 512.

FIG. 6 diagrammatically shows a second embodiment of the method according to the invention.

The method according to FIG. 6 comprises the following steps:
at an ongoing instant when a pointer is located on a specific location of a graphic interface displayed by the display means, the remote movement recognition means identify a movement called the validation movement made by the user. Said specific location corresponds to a request to display maintenance assistance information related to a particular maintenance operation;
reception of data related to the validation movement and supply of a validation command by the control module, in response;
reception of the validation command by the computer means. In response to this validation command, the computer means control the display of maintenance assistance information related particularly to said maintenance operation, through the display means;
the display means display said maintenance assistance information related particularly to said maintenance operation.

These steps together form a single step 612 that forms a variant of step 512 as described with reference to FIG. 5.

The computer means in particular control the display of maintenance assistance information related to a first step in said maintenance operation.

The method according to FIG. 6 then includes the following steps:
at a first instant of interest, identification of a movement of the human operator related to a request to fix the content of a display shown on the display means, by the remote movement recognition means;
reception by the control module of data related to the identified movement and in response, output a control command called the blocking command to fix the content of the display shown on the display means;
reception of said blocking command by the computer means, and in response control to fix the content of the display shown on the display means;
the display means fix the content of the display shown at the first instant of interest.

These steps together correspond to a step 622 that form a variant of step 512 as described with reference to FIG. 5.

As a variant, the display can be fixed by recognition of the validation movement when the pointer is on a corresponding location.

In step 60, the user then performs the first step of said maintenance operation. Since the display is fixed, movements made around the engine do not modify the display shown on the display means.

The method according to FIG. 6 then includes the following steps:
at an instant called the second instant of interest, later than the first instant of interest, the remote movement recognition means identify a movement related to a request to release said content of the display;
the control module receives data related to the identified movement and in response outputs a so-called release command, that releases the content of the display;
reception of said release command by the computer means and in response, control the stopping of fixing the content of the display;
the display means release the content of the display shown at the second instant of interest.

These steps together correspond to a step 632 that forms a variant of step 512 as described with reference to FIG. 5.

As a variant, the display is released by recognition of the validation movement when the pointer is at a corresponding location.

The method according to FIG. 6 then includes the following steps:
identification, by the remote movement recognition means, of a movement related to a request for recording the performance of a step in a maintenance operation;
reception by the control module of data related to the identified movement, and in response outputting a command called the recording command to record performance of said step;
reception of said recording command by the computer means, and in response control recording of information according to which said step is done.

As a variant, this recording is obtained by recognition of the validation movement when the pointer is located on a corresponding location.

The method may then include identification of a specific movement directly associated with a specific control command, by the remote movement recognition means. This specific movement may for example be a scanning movement towards the right. In response to said specific control command, the computer means control the display of information about a subsequent step in the maintenance operation.

As a variant, as soon as completion of a step has been recorded, the computer means will automatically control display of the information related to the subsequent step in the maintenance operation.

FIG. 7 shows a user 340 performing a movement in front of a device 300 according to the invention. The user 340 is in position in front of the display means 320 according to the invention. FIG. 7 also shows computer means 310 and an aircraft engine 350 on which the user 340 is required to perform a maintenance operation. The engine 350 is usually put down on a support (not shown). Connections between the display means 320, the computer means 310 and the human-machine interface 330 are not shown, to avoid cluttering FIG. 7.

The human-machine interface according to the invention comprises means 331 for remotely recognizing a movement (remote movement recognition means) and a control module. In practice, the remote movement recognition means 331 may be arranged in a first box located on the display means, and the control module may correspond to the same processor as the computer means 310 according to the invention.

The method and device according to the invention are advantageously used in an aircraft engine maintenance workshop. It may be a maintenance workshop dedicated to maintenance of aircraft engines, or dedicated to training of technicians specialised in maintenance of aircraft engines.

1. A device for assistance with maintenance of an aircraft engine, comprising:
computer means;
display means connected to the computer means;
a human-machine interface for the computer means;
remote movement recognition means, designed to remotely identify a movement or a position of a human operator, and to output data related to the identified movement or position; and
a control module, designed to provide the computer means with a control command, in response to reception of data related to the identified movement or position,
wherein the computer means are designed to:
control the display of information for assistance with maintenance of the aircraft engine, on the display means, in response to said control command, and
control holding the content of a display shown on the display means, in response to the reception of the control command, output by the control module in response to the reception of said data related to the identified movement or position.

2. The device according to claim 1, wherein the remote movement recognition means comprise a camera to acquire a series of human operator images and means of analysis of images designed to identify a movement or a position of the human operator from said series of images.

3. The device according to claim 1, wherein:
data related to the identified movement or position comprise an identifier of a specific movement or a specific position;
the control module includes a database containing a series of specific movement identifiers and/or specific position identifiers, this database associating a specific control command with each identifier; and
the computer means are designed to control the display of information for said assistance with maintenance of the aircraft engine, this display depending on said specific control command output by the control module.

4. The device according to claim 1, wherein:
the control module is adapted to move a pointer on a graphic interface displayed by the display means, in response to identification of a movement or a position of the human operator by the remote movement recognition means; and
the computer means are designed to control the display of information for said assistance with the maintenance of the aircraft engine, this display depending on the control command, called a validation command, output by the control module, and on the position of said pointer on a specific location of the graphic interface when said validation command is received by the computer means.

5. The device according to claim 1, wherein the computer means are designed to control release of the content of a display shown on the display means, in response to the reception of the control command, itself output by the control module in response to the reception of said data related to the identified movement or position.

6. The device according to claim 1, wherein:
the computer means are designed to control the display of maintenance assistance information related to at least one aircraft maintenance operation, each maintenance operation including at least one maintenance step, said information being displayed by the display means; and
the computer means are designed to control a record of the performance of a step in a maintenance operation in response to reception of the control command, itself output by the control module in response to reception said of data related to the identified movement or position.

7. A method for assisting the maintenance of an aircraft engine, comprising the following steps:
identifying a movement or a position of a human operator, by a remote movement recognition means, and send data related to the identified movement or position;
receiving, by a control module, said data related to the identified movement or position, and in response outputting a control command;
receiving, by a computer means, said control command, and in response controlling a display of information; and
displaying said information by a display means connected to the computer means,
wherein said information is information for said assistance with the maintenance of the aircraft engine, and in that control of the display of information for said assistance with the maintenance of the aircraft engine includes control of holding the content of a display shown on the display means, in response to the reception of the control command, itself output by the control module in response to the reception of said data related to the identified movement or position.

8. The method according to claim 7, wherein the data related to the identified movement or position comprise an identifier of a specific movement or a specific position, and in that the method includes the following steps:
the control module making said identifier and a specific control command correspond, to provide the computer means with said specific control command; and
the computer means controlling the display of information for said assistance with the maintenance of an aircraft engine, depending on said specific control command.

9. The method according to claim 7, further comprising the following steps:
displacing a pointer by remote recognition of a movement of a human operator, to bring the pointer to a specific location on a graphic interface displayed by the display means; and
the computer means controlling the display of information for said assistance with the maintenance of the aircraft engine, as a function of the control command called a validation command output by the control module, and of the position of said pointer on a specific position on the graphic interface when said validation command is received by the computer means.

10. The method according to claim 7, wherein it includes a step in which the human operator performs a maintenance operation on an aircraft engine, using maintenance assistance information displayed by the display means in response to an identified movement or a position.

11. The method according to claim 7, wherein the remote movement recognition means performs the following steps:
acquiring a series of images of the human operator;
analysing said series of images to identify a movement or a position of the human operator.

12. The method according to claim 7, wherein the control of the aircraft engine maintenance assistance information display includes control of releasing the content of a display, in response to reception of the control command, itself output by the control module in response to reception of data related to an identified movement or position.

13. The method according to claim 7, wherein:
the maintenance assistance information comprises information about at least one maintenance operation, each maintenance operation comprising at least one maintenance step; and
the method includes a control step performed by the computer means, in response to reception of the control command, itself output by the control module in response to reception of data related to an identified movement or position, to record that a step in a maintenance operation has been performed.
